(19) United States
(12) Patent Application Publication
(10) Pub. No.: US 2014/0165013 A1
(43) Pub. Date: Jun. 12, 2014

(54) ELECTRONIC DEVICE AND PAGE ZOOMING METHOD THEREOF

(71) Applicants: HON HAI PRECISION INDUSTRY CO., LTD., New Taipei (TW); HONG FU JIN PRECISION INDUSTRY (ShenZhen) CO., LTD ., Shenzhen (CN)

(72) Inventors: Chia-Hao Chuang, New Taipei (TW); Chih-San Chiang, New Taipei (TW); Sai-Rong Huang, Shenzhen (CN); Huai-Yu Shang, Shenzhen (CN); Wei Liu, Shenzhen (CN); Hui Lan, Shenzhen (CN)

(73) Assignees: HON HAI PRECISION INDUSTRY CO., LTD., New Taipei (TW); HONG FU JIN PRECISION INDUSTRY (ShenZhen) CO., LTD ., Shenzhen (CN)

(21) Appl. No.: 14/079,646

(22) Filed: Nov. 14, 2013

(30) Foreign Application Priority Data
Dec. 6, 2012 (CN) 2012105177850

(51) Int. Cl. G06F 3/0488

(52) U.S. Cl. CPC G06F 3/0488
USPC 715/863

(57) ABSTRACT

A page zooming method for an electronic device includes, firstly, generating operation signals in response to a touch operation applied on a page displayed on a touch screen of the electronic device. Secondly, one touch operation is determined to be a zoom-triggering gesture when a duration of time of pressing the touch screen on one touching point is longer than a first preset duration of time. Thirdly, one slide operation is identified according to the operation signals generated by the touch screen in response to the slide operation. Next, a zooming type and a zooming ratio are determined according to the zoom-triggering gesture and the slide operation. Lastly, the page is zoomed according to the zooming type and zooming ratio. An electronic device using the page zooming method is also provided.

### BACKGROUND

1. Technical Field

The present disclosure relates to an electronic device and a page zooming method for the electronic device.

2. Description of Related Art

Nowadays, there are numerous kinds of electronic devices with touch screens, e.g., mobile phones, tablet personal computers, digital cameras, digital photo frames, and electronic readers (e-readers). Typically, these electronic devices are capable of zooming the page displayed on the touch screen in response to a user's operations on the touch screen. Generally, for zooming in the user's view of the displayed page, the user uses two fingers sliding away from each other. Conversely, for zooming out the user's view of the displayed page, the user uses two fingers sliding towards each other. Thus, two fingers must be employed at the same time to zoom the page, which may not be convenient for users in certain situations.

Therefore, what is needed is an electronic device with a touch screen and a page zooming method thereof which can alleviate the limitations described above.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts or sections throughout the views.

FIG. 1 is a block diagram of an electronic device with a touch screen in accordance with an exemplary embodiment.

FIG. 2 is a schematic diagram showing a sliding gesture displayed on the touch screen of the electronic device of FIG. 1, in accordance with the exemplary embodiment.

FIG. 3 is a schematic diagram showing a different sliding gesture displayed on the touch screen of the electronic device of FIG. 1, in accordance with the exemplary embodiment.

FIGS. 4 and 5 together constitute a single flowchart of a page zooming method for an electronic device, such as the one of FIG. 1, in accordance with an exemplary embodiment.

FIG. 6 is a flowchart of details of one step of the page zooming method shown in FIG. 5, in accordance with the exemplary embodiment.

### DETAILED DESCRIPTION

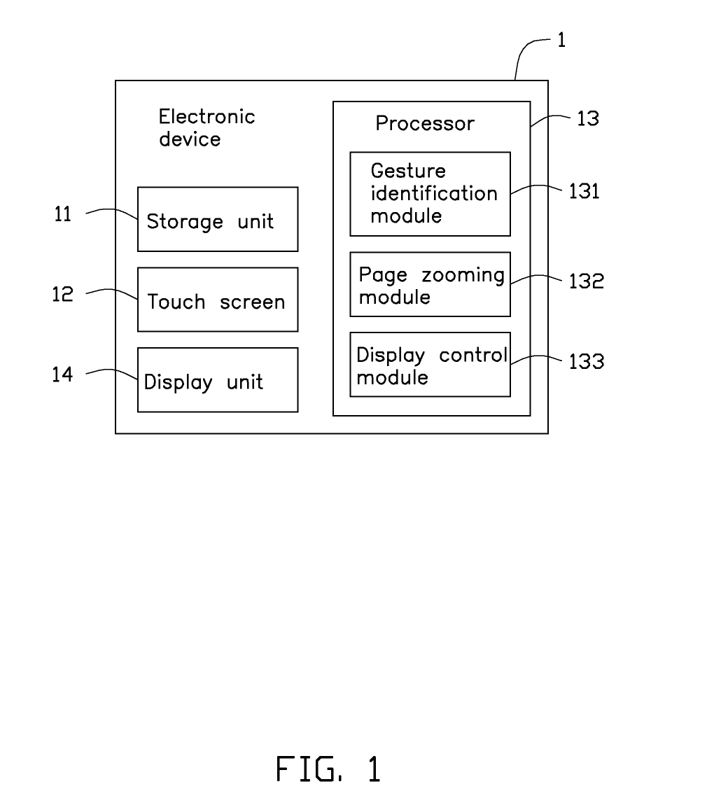

FIG. 1 is a block diagram of an exemplary embodiment of an electronic device 1. The electronic device 1 includes a touch screen 12. The electronic device 1 is able to zoom in and zoom out pages and/or contents displayed on the touch screen 12 in response to corresponding touch operations. The electronic device 1 is typically a mobile appliance with a touch screen, such as a mobile phone, an electronic reader, a tablet personal computer, a digital camera, or a digital photo frame, for example.

The electronic device 1 further includes a storage unit 11, a processor 13 and a display unit 14. The storage unit 11 stores information in the form of a number of electronic files. The electronic files may be image electronic files. Each image electronic file comprises one or more pictures and/or photographs, and/or may be a text or data based electronic file such as Microsoft® Word. Each text or data based electronic file may contain one or more pictures and/or photographs. The touch screen 12 is configured for generating corresponding operation signals in response to a manual touch operation thereon. For example, for a given electronic file, operations of flipping a displayed page, zooming in or out of a displayed page, selecting a page, or dragging a displayed page, can be performed by touching the touch screen 12.

The processor 13 includes a gesture identification module 131, a page zooming module 132, and a display control module 133.

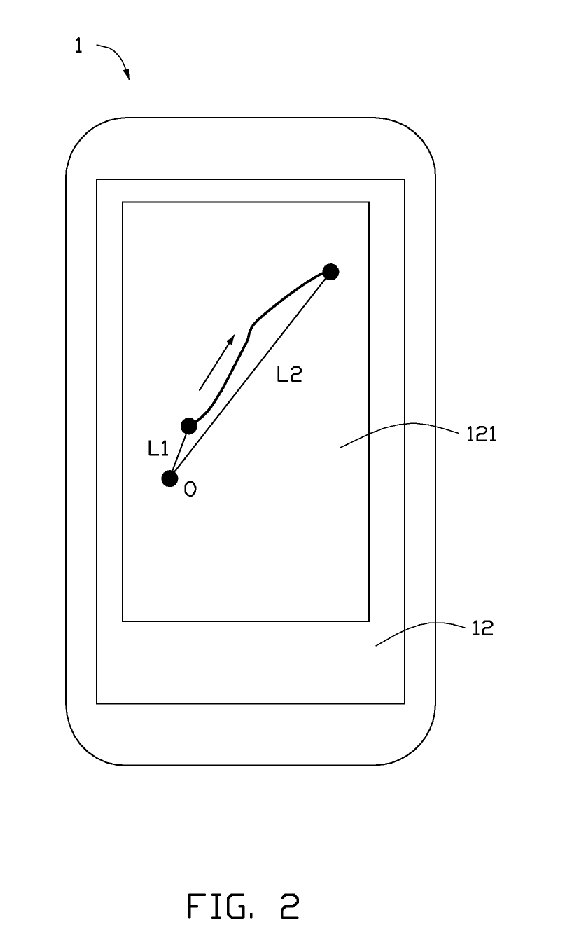

Referring to FIG. 2, when the electronic device 1 is activated, the touch screen 12 displays a default icon interface, and the user touches any one of the default icons displayed on the default icon interface to display a window and show a page 121. For example, the page 121 is a Microsoft® Word page or the like, which includes text and/or pictures and/or figures. In another example, the page 121 is a web page or the like, which includes text and/or pictures and/or figures. If a zooming gesture is applied on the page 121, the page 121 is zoomed accordingly.

The gesture identification module 131 is configured for identifying a touch operation according to operation signals generated by the touch screen 12 in response to the touch operation. The gesture identification module 131 is also configured for determining whether the identified touch operation is a zoom-triggering gesture. The gesture identification module 131 is further configured for controlling the page 121 to enter a page-zooming state when it is determined that the identified touch operation is the zoom-triggering gesture. In this embodiment, the zoom-triggering gesture is an operation of pressing the touch screen 12 on one touching point for a duration of time longer than a first preset duration of time. In the following description, unless the context indicates otherwise, “press” or “pressing” is performed by a user's fingertip. However, in other embodiments, “press” or “pressing” may be performed by other means such as with a stylus.

After entering the page-zooming state, the gesture identification module 131 is further configured for determining whether an identified touch operation is a zoom-terminating gesture, and still further configured for controlling the page 121 to exit the page-zooming state when it is determined that the identified touch operation is the zoom-terminating gesture. In this embodiment, the zoom-terminating gesture is an operation of pressing the touching screen 12 on one touching point for a duration of time longer than a second preset duration of time.

The gesture identification module 131 is further configured for controlling the page 121 to exit the page-zooming state when there is no operation signal generated in a third preset duration of time.

In this exemplary embodiment, the first preset duration of time, the second preset duration of time and the third preset duration of time are preset in the electronic device 1 at the time of manufacture. In an alternative exemplary embodiment, the first preset duration of time, the second preset duration of time are preset by a user. In this exemplary embodiment, the first preset duration of time, the second preset duration of time and the third preset duration of time are different from each other. For example, the first preset duration of time is 3 seconds, the second preset duration of time is 5 seconds, and the third preset duration of time is 7 seconds.

In detail, the gesture identification module 131 is configured for identifying the touch operation which contains a touching point on the touch screen 12 according to the operation signals. The gesture identification module 131 is configured for determining whether the identified touch operation is the zoom-triggering gesture; and the gesture identification module 131 controls the page 121 to enter the page-zooming state when it is determined that the duration of time of the touching point pressed is longer than the first preset duration of time. After the page 121 enters the page-zooming state, the gesture identification module 131 is configured for identifying a slide operation according to operation signals generated by the touch screen 12 in response to the slide operation. In this embodiment, the slide operation is an operation performed after the user has pressed the touching point longer than the first preset time duration and lifted his/her fingertip off from the touching point.

The page zooming module 132 is configured for determining an origin point O according to the zoom-triggering gesture. In this embodiment, the touching point of the zoom-triggering gesture is taken as the origin point O. The page zooming module 132 is further configured for determining a zooming type and a zooming ratio according to the zoom-triggering gesture and the slide operation, and zooming the page 121 in or out according to the determined zooming type and zooming ratio. In this embodiment, the page zooming module 132 is configured for determining the zooming type according to whether the slide direction of the slide operation is towards the origin point O or away from the origin point O, and for determining the zooming ratio according to distances between positions of the user's slide operation on the touch screen and the origin point O.

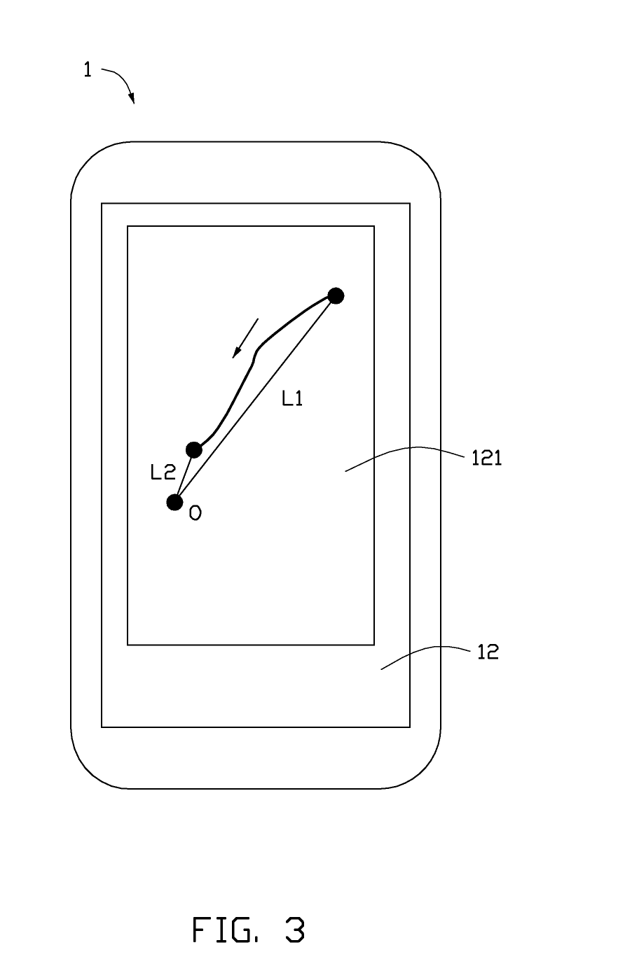

FIG. 2 illustrates a slide operation of sliding away from the origin point O. In this embodiment, when the slide direction of the slide operation on the touch screen 12 is away from the origin point O, the page zooming module 132 determines that the zooming type is a zooming in type. FIG. 3 illustrates a slide operation of sliding towards the origin point O. In this embodiment, when the slide direction of the slide operation on the touch screen 12 is towards the origin point O, the page zooming module 132 determines that the zooming type is a zooming out type.

In detail, the page zooming module 132 is configured to determine a first distance L1 between a starting point of the slide operation and the origin point O, determine a second distance L2 between an ending point of the slide operation and the origin point O, and calculate a comparison result between the first distance L1 and the second distance L2. When the second distance L2 is larger than the first distance L1, the page zooming module 132 determines that the slide direction of the slide operation on the touch screen 12 is away from the origin point O, and so the page zooming module 132 determines that the zooming type is the zooming in type. When the second distance L2 is less than the first distance L1, the page zooming module 132 determines that the slide direction of the slide operation on the touch screen 12 is towards the origin point O, and so the page zooming module 132 determines that the zooming type is the zooming out type.

The page zooming module 132 is further configured for calculating a difference value between the second distance L2 and the first distance L1, i.e. the value L2 minus L1. The page zooming module 132 is still further configured for determining the zooming ratio according to the difference value between the second distance L2 and the first distance L1. In detail, the page zooming module 132 is configured for determining the zooming ratio according to the difference value and a predetermined zooming factor. In this embodiment, when the difference value is greater than zero, the difference value multiplied by the zooming factor is equal to the zooming ratio. When the difference value is less than zero, the zooming factor is divided by the difference value to obtain the zooming ratio. For example, when the difference value between the second distance L2 and the first distance L1 is +2 inches, the page zooming module 132 determines that the zooming type is the zooming in type. Further, when the zooming factor is 100%, 2 inches multiplied by 100% is equal to 200%. That is, the zooming ratio is 200%, and the page zooming module 132 zooms the page 121 in 200%. In another example, when the difference value between the second distance L2 and the first distance L1 is −2 inches, the page zooming module 132 determines that the zooming type is the zooming out type. Further, when the zooming factor is 100%, 100% divided by −2 is equal to −50%. That is, the zooming ratio is −50%, and the page zooming module 132 zooms the page 121 out 50%.

In an alternative embodiment, when the slide direction of the slide operation on the touch screen 12 is away from the origin point O, the page zooming module 132 determines that the zooming type is the zooming out type. When the slide direction of the slide operation on the touch screen 12 is towards the origin point O, the page zooming module 132 determines that the zooming type is the zooming in type. In detail, referring to FIG. 2, when the second distance L2 is greater than the first distance L1, the page zooming module 132 determines that the slide direction of the slide operation on the touch screen 12 is away from the origin point O, and so the zooming type is the zooming out type. Referring to FIG. 3, when the second distance L2 is less than the first distance L1, the page zooming module 132 determines that the slide direction of the slide operation on the touch screen 12 is towards the origin point O, and so the zooming type is the zooming in type.

In the alternative embodiment, the page zooming module 132 is further configured for calculating the difference value between the first distance L1 and the second distance L2, i.e., the value L1 minus L2. When the difference value is greater than zero, the difference value multiplied by the zooming factor is equal to the zooming ratio; and when the difference value is less than zero, the zooming factor divided by the difference value is equal to the zooming ratio. For example, when the difference value between the first distance L1 and the second distance L2 is 3 inches, the page zooming module 132 determines that the zooming type is the zooming in type. Further, when the zooming factor is 100%, 3 inches multiplied by 100% is equal to 300%. That is, the zooming ratio is 300%, and the page zooming module 132 zooms the page 121 in 300%. When the difference value between the first distance L1 and the second distance L2 is −3 inches, the page zooming module 132 determines that the zooming type is the zooming out type. Further, when the zooming factor is 100%, 100% divided by −3 is equal to −33.3%. That is, the zooming ratio is −33.3%, and the page zooming module 132 zooms the page 121 out −33.3%.

In this description, the unit of measurement is inches. Of course, the unit of measurement can alternatively be centimeters, millimeters, and so on.

The above descriptions provide two ways to determine the zooming ratio. Of course, in alternative embodiments, other ways to determine the zooming ratio according to relative position relations between the slide operation (starting point and ending point) and the origin point may also be applied. For example, the zooming ratio can be determined according to a ratio between the difference value and the first distance L1, that is (L1-L2)/L1. In one detailed example, the zooming in ratio is (1+(L1-L2)/L1)×100%, and the zooming out ratio is (1−(L1-L2)/L1)×100%. Furthermore, in alternative embodiments, the above described “ending point” is not limited to the touching point where the slide operation finishes. Instead, the “ending point” can be the touching point where the finger is positioned at any given moment in time before the slide operation is finished.

The page zooming module 132 is further configured for zooming the page 121 according to the determined zooming type and zooming ratio. The display control module 133 is configured for controlling the display unit 14 to display the zoomed page 121.

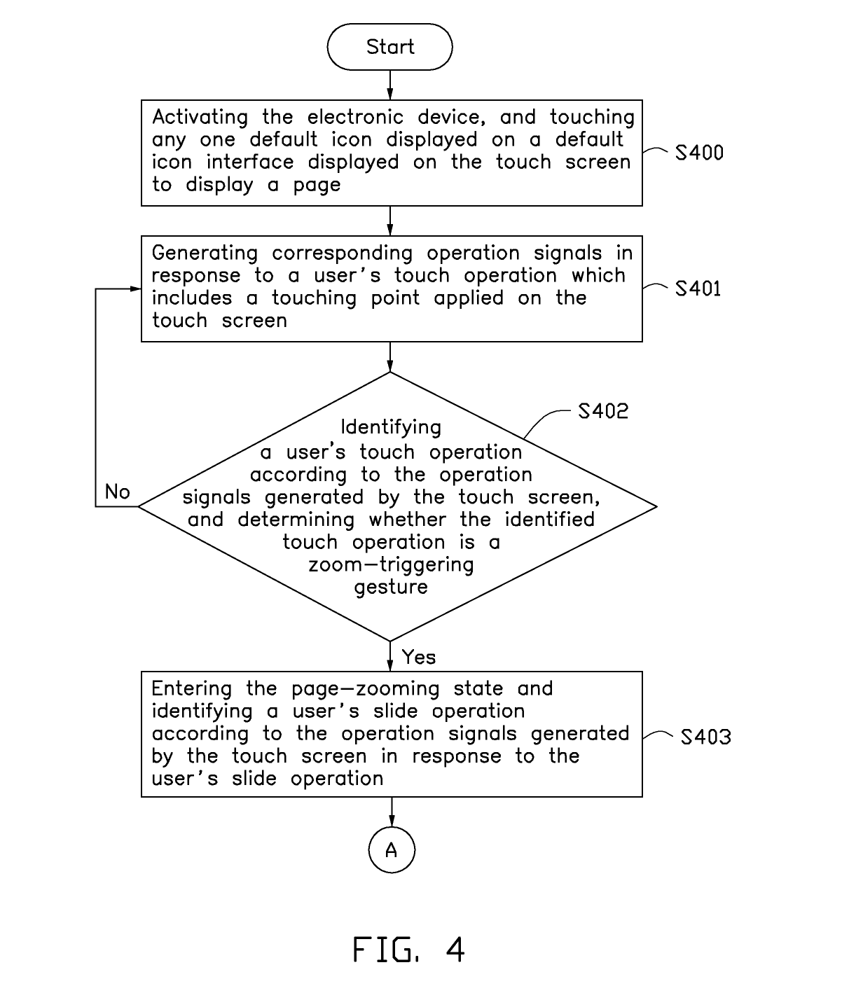

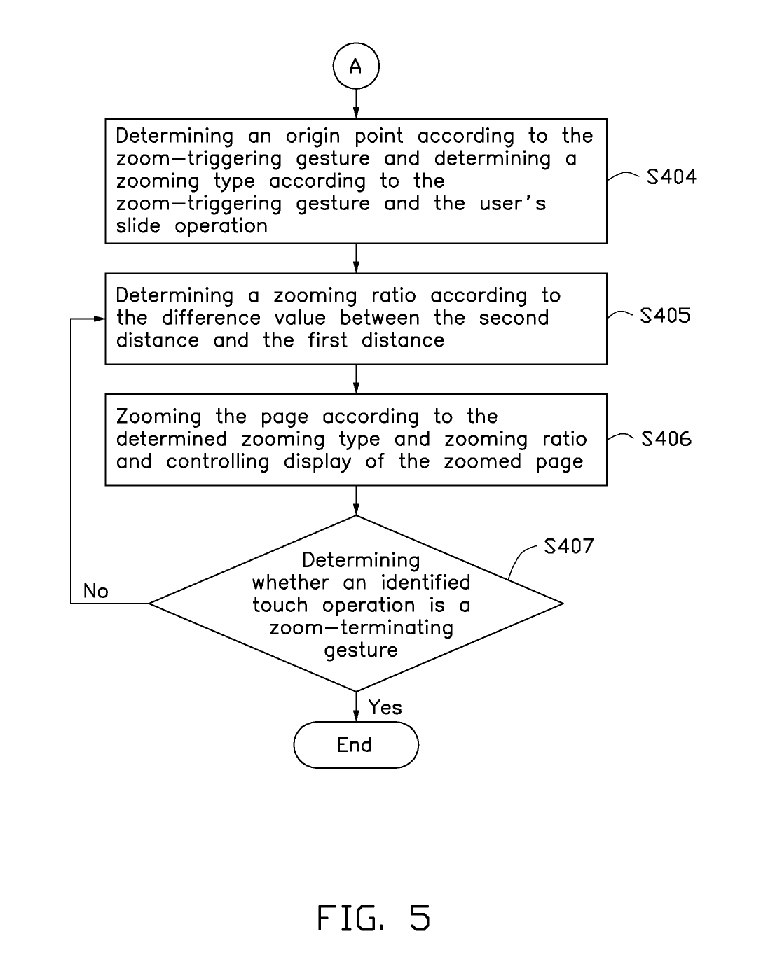

FIGS. 4 and 5 together constitute a single flowchart of an exemplary page zooming method of an electronic device such as the electronic device 1. The electronic device 1 includes a storage unit 11 and a touch screen 12. The touch screen 12 is configured for generating operation signals in response to touch operations. The method typically includes the following steps, each of which is related to the various components contained in the electronic device 1.

In step S400, when the electronic device 1 is activated, the touch screen 12 displays a default icon interface. The user touches any one default icon displayed on the default icon interface to display a window and show a page 121.

In step S401, the touch screen 12 generates corresponding operation signals in response to a touch operation applied thereon.

In step S402, the gesture identification module 31 identifies a touch operation according to operation signals generated by the touch screen 12 in response to the touch operation, and determines whether the identified touch operation is a zoom-triggering gesture. If the determination is yes, the process goes to step S403; otherwise, the process goes back to step S401. In this embodiment, the zoom-triggering gesture is an operation of pressing the touch screen 12 on one touching point for a duration of time longer than a first preset time duration.

In step S403, the gesture identification module 31 is configured for entering a page-zooming state and identifying a slide operation according to operation signals generated by the touch screen 12 in response to the slide operation.

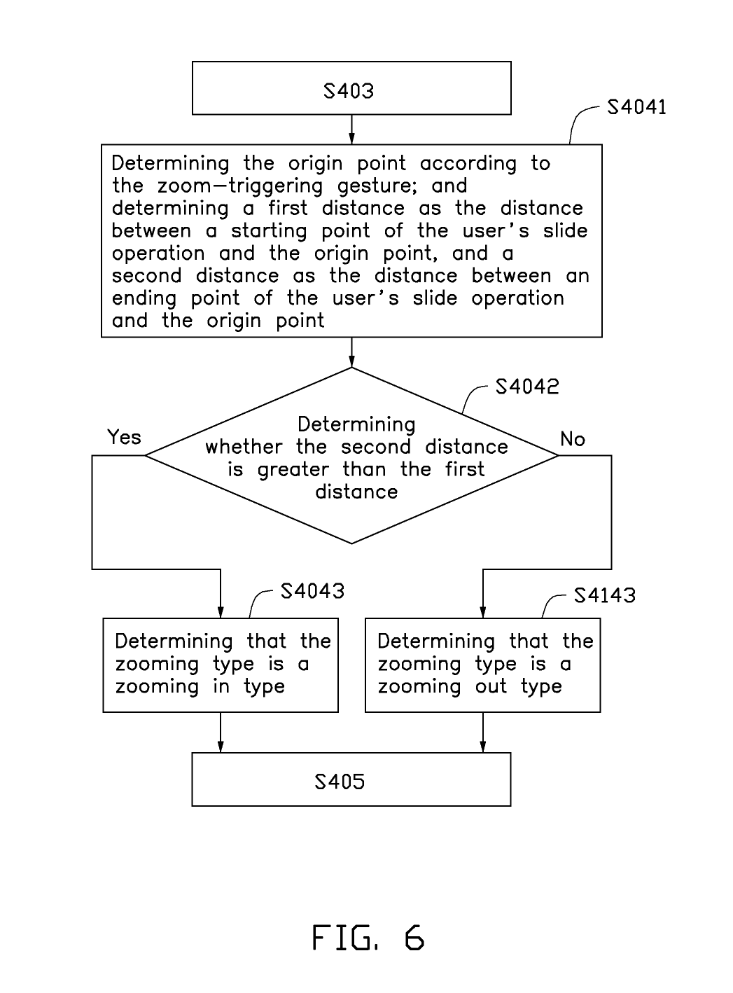

In step S404, the page zooming module 132 is configured for determining an origin point O according to the zoom-triggering gesture. The origin point O is the touching point of the zoom-triggering gesture. The page zooming module 132 is further configured for determining a zooming type and a zooming ratio according to the zoom-triggering gesture and the slide operation. Referring to FIG. 6, step S404 includes the following steps:

In step S4041, the page zooming module 132 is configured for determining the origin point O according to the zoom-triggering gesture. The page zooming module 132 is further configured for determining a first distance L1 and a second distance L2. The first distance L1 is the distance between a starting point of the slide operation and the origin point O, and the second distance L2 is a distance between an ending point of the slide operation and the origin point O. In detail, in this embodiment, when the duration of time of the touching point pressed on the touch screen 12 is longer than a first preset duration of time, the page 121 enters a page-zooming state. When the page 121 is in the page-zooming state, the page zooming module 132 is configured to take the touching point as the origin point O. The page zooming module 132 is further configured for determining the first distance L1 as the distance between the starting point of the slide operation and the origin point O, and determining the second distance L2 as the distance between the ending point of the slide operation and the origin point O.

In step S4042, the page zooming module 132 is configured for determining whether the second distance L2 is greater than the first distance L1. If the determination is yes, the process goes to step S4043; otherwise, the process goes to step S4143.

In step S4043, the page zooming module 132 is configured for determining that the zooming type is a zooming in type.

In step S4143, the page zooming module 132 is configured for determining that the zooming type is a zooming out type.

In step S405, the page zooming module 132 is further configured for determining the zooming ratio according to a difference value between the second distance L2 and the first distance L1. In detail, the page zooming module 132 is configured for determining the zooming ratio according to the difference value and a predetermined zooming factor. In this embodiment, the difference value multiplied by the zooming factor is equal to the zooming in ratio; and the zooming factor divided by the difference value is equal to the zooming out ratio. In other embodiments, for example, the zooming in ratio is (1+(L1-L2)/L1)×100%, and the zooming out ratio is (1−(L1-L2)/L1)×100%.

In step S406, the page zooming module 132 is further configured for zooming the page 121 in or out according to the determined zooming type and zooming ratio. The display control module 133 is configured for controlling the display unit 14 to display the zoomed page 121.

In step S407, after entering the page-zooming state, the gesture identification module 131 is further configured for determining whether an identified touch operation is a zoom-terminating gesture. If the determination is yes, the page-zooming state is exited; otherwise, the process goes back to step S405. In this embodiment, the zoom-terminating gesture is an operation of pressing the touch screen 12 on the touching point for a duration of time longer than a second preset duration of time. In another embodiment, the gesture identification module 131 is configured for exiting the page-zooming state when there is no operation signal generated in a third preset duration of time.

Although the present disclosure has been specifically described on the basis of various embodiments thereof, the disclosure is not to be construed as being limited thereto. Various changes or modifications may be made to the embodiments without departing from the scope and spirit of the disclosure.

What is claimed is:

1. A page zooming method for an electronic device having a touch screen and a storage unit, the method comprising:
generating operation signals in response to a touch operation, which includes a touching point applied on a page displayed on the touch screen;
determining that the touch operation is a zoom-triggering gesture when the touch operation is pressing the touch screen on one touching point for a duration of time longer than a first preset duration of time, and entering a page-zooming state;
identifying a slide operation performed on the touch screen according to operation signals generated by the touch screen in response to the slide operation;
determining a zooming type and a zooming ratio according to the zoom-triggering gesture and the slide operation, wherein the zooming type is a zooming in type or a zooming out type;
zooming the page displayed on the touch screen according to the zooming type and zooming ratio; and
displaying the zoomed page on the touch screen.

2. The method as described in claim 1, wherein determining a zooming type and a zooming ratio according to the zoom-triggering gesture and the slide operation comprises:
determining an origin point according to the zoom-triggering gesture;
determining that the zooming type is the zooming in type when the slide operation is sliding away from the origin point; and
determining that the zooming type is the zooming out type when the slide operation is sliding towards the origin point.

3. The method as described in claim 2, wherein determining that the zooming type is a zooming in type when the slide operation is sliding away from the origin point and determining that the zooming type is a zooming out type when the slide operation is sliding towards the origin point comprise:
determining a first distance as the distance between a starting point of the slide operation and the origin point, and a second distance as the distance between an ending point of the slide operation and the origin point;
determining whether the second distance is greater than the first distance;
determining that the zooming type is the zooming in type when the second distance is greater than the first distance; and
determining that the zooming type is the zooming out type when the second distance is less than the first distance.

4. The method as described in claim 2, wherein the zooming ratio is determined according to a difference value between the second distance and the first distance and a predetermined zooming factor; and when the zooming type is determined to be the zooming in type, the zooming ratio is equal to the difference value multiplied by the zooming factor; and when the zooming type is determined to be the zooming out type, the zooming ratio is equal to the zooming factor divided by the difference value.

5. The method as described in claim 1, wherein determining a zooming type and a zooming ratio according to the zoom-triggering gesture and the slide operation comprises:
determining an origin point according to the zoom-triggering gesture;
determining that the zooming type is the zooming in type when the slide operation is sliding towards the origin point; and
determining that the zooming type is the zooming out type when the slide operation is sliding away from the origin point.

6. The method as described in claim 5, wherein determining that the zooming type is the zooming in type when the slide operation is sliding towards the origin point and determining that the zooming type is the zooming out type when the slide operation is sliding away from the origin point comprise:
determining a first distance as the distance between a starting point of the slide operation and the origin point, and a second distance as the distance between an ending point of the slide operation and the origin point;
determining whether the first distance is greater than the second distance;
determining that the zooming type is the zooming in type when the first distance is greater than the second distance; and
determining that the zooming type is the zooming out type when the first distance is less than the second distance.

7. The method as described in claim 5, wherein the zooming ratio is determined according to a difference value between the first distance and the second distance and a predetermined zooming factor; and when the zooming type is determined to be the zooming in type, the zooming ratio is equal to what the difference value multiplied by the zooming factor; and when the zooming type is determined to be the zooming out type, the zooming ratio is equal to the zooming factor divided by the difference value.

8. The method as described in claim 1, further comprising, after entering the page-zooming state:
identifying another touch operation performed on the touch screen;
determining whether the identified another touch operation is a zoom-terminating gesture; and
exiting the page-zooming state when the identified another touch operation is the zoom-terminating gesture.

9. The method as described in claim 8, wherein the zoom-terminating gesture is pressing the touch screen on one touching point for a duration of time longer than a second preset duration of time.

10. The method as described in claim 9, wherein the second preset duration of time is different from the first preset duration of time.

11. The method as described in claim 1, further comprising, after entering the page-zooming state:
exiting the page-zooming state when there is no operation signal generated in a second preset duration of time.

12. An electronic device, comprising:
a touch screen, configured for generating operation signals in response to a touch operation applied on a page displayed thereon;
a gesture identification module, configured for determining that the identified touch operation is a zoom-triggering gesture when the touch operation is pressing the touch screen on one touching point for a duration of time longer than a first preset duration of time, for entering a page-zooming state when the identified touch operation is the zoom-triggering gesture, and for identifying a slide operation performed on the touch screen according to operation signals generated by the touch screen in response to the slide operation;
a page zooming module, configured for determining a zooming type and a zooming ratio according to the zoom-triggering gesture and the slide operation, wherein the zooming type comprises a zooming in type and a zooming out type;
and
a display control module, configured for displaying the zoomed page on the touch screen.

13. The electronic device as described in claim 12, wherein the page zooming module is further configured for determining an origin point according to the zoom-triggering gesture; the page zooming module is further configured for determining that the zooming type is the zooming in type when the slide operation is sliding away from the origin point and determining that the zooming type is the zooming out type when the slide operation is sliding towards the origin point.

14. The electronic device as described in claim 13, wherein the page zooming module is further configured for determining a first distance as the distance between a starting point of the slide operation and the origin point, and a second distance as the distance between an ending point of the slide operation and the origin point; and the page zooming module is further configured for determining whether the second distance is greater than the first distance, and determining that the zooming type is the zooming in type when the second distance is greater than the first distance, and determining that the zooming type is the zooming out type when the second distance is less than the first distance.

15. The electronic device as described in claim 14, wherein the page zooming module is further configured for determining the zooming ratio according to a difference value between the second distance and the first distance, and a predetermined zooming factor; and when the zooming type is determined to be the zooming in type, the zooming ratio is equal to the difference value multiplied by the zooming factor; and when the zooming type is determined to be the zooming out type, the zooming ratio is equal to the zooming factor divided by the difference value.

16. The electronic device as described in claim 12, wherein the page zooming module is further configured to take the touching point of the zoom-triggering gesture as an origin point; and the page zooming module is further configured for determining that the zooming type is the zooming in type when the slide operation is sliding towards the origin point, and determining that the zooming type is the zooming out type when the slide operation is sliding away from the origin point.

17. The electronic device as described in claim 16, wherein the page zooming module is further configured for determining a first distance as the distance between a starting point of the slide operation and the origin point, and a second distance as the distance between an ending point of the slide operation and the origin point; and the page zooming module is further configured for determining whether the first distance is greater than the second distance, and determining that the zooming type is the zooming in type when the first distance is greater than the second distance, and determining that the zooming type is the zooming out type when the first distance is less than the second distance.

18. The electronic device as described in claim 17, wherein the page zooming module is further configured for determining the zooming ratio according to a difference value between the first distance and the second distance, and a predetermined zooming factor; and when the zooming type is determined to be the zooming in type, the zooming ratio is equal to the difference value multiplied by the zooming factor; and when the zooming type is determined to be the zooming out type, the zooming ratio is equal to the zooming factor divided by the difference value.

19. The electronic device as described in claim 12, wherein the gesture identification module is further configured for identifying another touch operation performed on the touch screen when the electronic device is in the page-zooming state, and determining whether the identified another touch operation is a zoom-terminating gesture; and the gesture identification module is further configured for exiting the page-zooming state when the identified another touch operation is the zoom-terminating gesture; the zoom-terminating gesture is pressing the touch screen on one touching point for a duration of time longer than a second preset duration of time, and the second preset duration of time is different from the first preset duration of time.

20. The electronic device as described in claim 12, wherein the gesture identification module is further configured for exiting the page-zooming state when the electronic device is in the page-zooming state and there is no operation signal generated in a second preset duration of time.
